(19) United States
(12) Patent Application Publication
(10) Pub. No.: US 2019/0114491 A1
(43) Pub. Date: Apr. 18, 2019

(54) VEHICLE CONTROL APPARATUS AND VEHICLE CONTROL METHOD

(71) Applicant: DENSO CORPORATION, Kariya-city, Aichi-pref. (JP)

(72) Inventor: Ryo TAKAKI, Kariya-city, Aichi-pref. (JP)

(21) Appl. No.: 16/090,037

(22) PCT Filed: Mar. 31, 2017
(86) PCT No.: PCT/JP2017/013834

§ 371 Date: Sep. 28, 2018

(30) Foreign Application Priority Data
Apr. 1, 2016 (JP) 2016-074642

(51) Int. Cl. G06K 9/00; G06T 7/20; G05D 1/02

(52) U.S. Cl. CPC G06K 9/00805; G06T 7/20; G05D 2201/0213; G06T 2207/30261; G05D 1/0246

(57) ABSTRACT

An ECU sets, as a movement direction of an object relative to an own vehicle, a first direction in which recognition accuracy of a recognition result is high and a second direction in which the recognition accuracy is lower than that in the first direction. The ECU includes: a movement determination section which determines whether movement of a target is movement in the first direction or movement in the second direction; a first type determination section which determines the type of the object based on the recognition result during the movement in the first direction, when the movement is the movement in the first direction; and a second type determination section which determines the type of the object by using a determination history stored by the first type determination section, when the movement has changed from the movement in the first direction to the movement in the second direction.

### CROSS-REFERENCE TO RELATED APPLICATIONS

The present application claims the benefit of priority from Japanese Patent Application No, 2016-074642 filed on Apr. 1, 2016, the description of which is incorporated herein by reference.

### TECHNICAL FIELD

The present disclosure relates to a vehicle control apparatus and a vehicle control method which determine a type of an object on the basis of an image captured by an imaging means.

### BACKGROUND ART

Patent Literature 1 discloses an apparatus which recognizes a type of an object in a captured image. The apparatus described in Patent Literature 1 detects, in the captured image, a plurality of pixel points whose motion vectors have the same magnitude and direction, and extracts a region surrounding the pixel points as a region of the object. Then, the apparatus recognizes the type of the object by performing well-known template matching with respect to the extracted region.

### CITATION LIST

### Patent Literature

[PTL 1] JP 2007-249841 A

### SUMMARY OF THE INVENTION

In a certain movement direction, different types of objects may be erroneously recognized as the same type of objects. For example, as for a bicycle and a pedestrian, when objects have similar widths when viewed from a predetermined direction or have the same characteristics, accuracy in recognizing the objects which are moving in a certain direction may decrease. When the type of an object is erroneously recognized, an apparatus which determines the type of the object on the basis of the recognition result may erroneously determine the type of the object.

The present disclosure has been made in light of the above problems, and has an object of providing a vehicle control apparatus and a vehicle control method which reduce erroneous determination of the type of an object on the basis of a movement direction of the object.

The present disclosure is an object detection apparatus which acquires a recognition result related to an object based on an image captured by an imaging means and detects the object based on the recognition result, the object detection apparatus including: a movement determination section which determines whether movement of the object relative to an own vehicle is movement in a first direction in which recognition accuracy for the object is high or movement in a second direction in which the recognition accuracy is lower than that in the first direction; a first type determination section which determines a type of the object based on the recognition result, when the movement of the object is the movement in the first direction; and a second type determination section which determines the type of the object by using a determination history stored by the first type determination section, when the movement of the object has changed from the movement in the first direction to the movement in the second direction.

For example, the recognition accuracy when the object is moving longitudinally relative to the own vehicle may differ from the recognition accuracy when the object is moving laterally relative to the own vehicle. Furthermore, when a two-wheeled vehicle is to be detected, the recognition accuracy in a state where the two-wheeled vehicle is directed longitudinally relative to the own vehicle may be lower than the recognition accuracy in a state where the two-wheeled vehicle is directed laterally relative to the own vehicle. Thus, when the movement of the object has been determined to be movement in the first direction in which the recognition accuracy is high, the first type determination section determines the type of the object based on the recognition result. Furthermore, when the movement of the object has changed from the movement in the first direction to the movement in the second direction in which the recognition accuracy is lower than that in the first direction, the second type determination section determines the type of the object by using the determination history stored by the first type determination section. Accordingly, when the movement of the object is the movement in the second direction in which the recognition accuracy is low, the type of the object is determined based on the determination history stored during the movement in the first direction, and this makes it possible to prevent erroneous determination of the type of the object.

### BRIEF DESCRIPTION OF THE DRAWINGS

The above object and other objects, features, and advantages of the present disclosure will be clarified by the following detailed description with reference to the accompanying drawings, wherein:

FIG. 1 is a block diagram illustrating a driving assistance apparatus;

FIG. 2 is a view illustrating types of targets recognized by an object recognition section;

FIG. 3 is a flow chart showing an object detection process for determining the type of a target Ob on the basis of a recognition result acquired from a camera sensor;

FIG. 4 is a view illustrating calculation of a movement direction of the target Ob in step S12;

FIG. 5 is a view showing a relationship between recognition accuracy of the camera sensor and a direction of the target Ob;

FIG. 6 is a view illustrating recognition of the target Ob by a type determination process;

FIG. 7 is a view illustrating recognition of the target Ob by the type determination process; and

FIG. 8 is a flow chart showing a process performed by an ECU 20 in a second embodiment.

### DESCRIPTION OF THE EMBODIMENTS

Embodiments of a vehicle control apparatus will be described with reference to the drawings. In the following description, the vehicle control apparatus is part of a driving assistance apparatus which assists driving of an own vehicle. In the following embodiments, the same or equivalent parts are given the same reference numerals in the drawings, and the parts given the same reference numerals are described using the same designations for the parts.

### First Embodiment

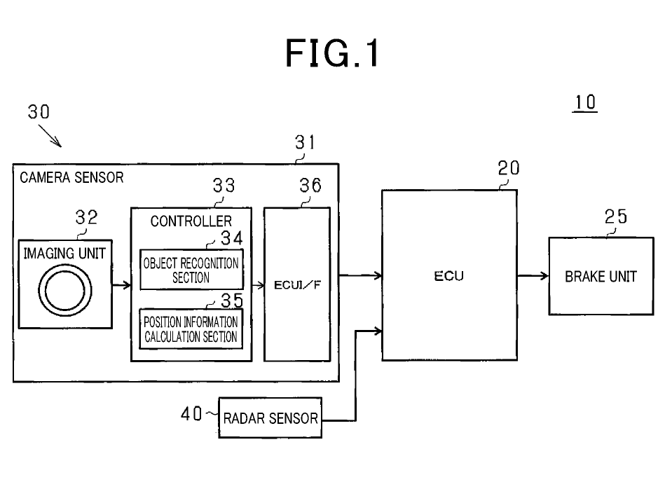

FIG. 1 illustrates a driving assistance apparatus 10 to which a vehicle control apparatus and a vehicle control method are applied. The driving assistance apparatus 10 is installed in a vehicle and monitors movement of an object located ahead of the vehicle. If there is a probability that the object and the vehicle collide with each other, the driving assistance apparatus 10 provides pre-crash safety (PCS) which is action for avoiding the collision or action for mitigating the collision by automatic braking. As illustrated in FIG. 1, the driving assistance apparatus 10 includes various sensors 30, an ECU 20, and a brake unit 25. In the embodiment illustrated in FIG. 1, the ECU 20 functions as the vehicle control apparatus.

In the following description, a vehicle equipped with the driving assistance apparatus 10 is referred to as own vehicle CS. Furthermore, an object which is recognized by the driving assistance apparatus 10 is referred to as a target Ob.

The various sensors 30 are connected to the ECU 20 and output a recognition result related to the target Ob to the ECU 20. In FIG. 1, the sensors 30 include a camera sensor 31 and a radar sensor 40.

The camera sensor 31 is provided on a front side of the own vehicle CS and recognizes the target Ob which is located ahead of the own vehicle. The camera sensor 31 includes an imaging unit 32 corresponding to an imaging means which acquires a captured image, a controller 33 which performs well-known image processing with respect to the captured image acquired by the imaging unit 32, and an ECU I/F 36 which enables communication between the controller 33 and the ECU 20.

The imaging unit 32 includes a lens section which functions as an optical system and an imaging element which converts light collected through the lens section into an electrical signal. The imaging element is constituted by a well-known imaging element such as a CCD or a CMOS. The electrical signal converted by the imaging element is stored as a captured image in the controller 33 through the ECU I/F 36.

The controller 33 is constituted by a well-known computer which includes a CPU, a ROM, a RAM, and the like. The controller 33 functionally includes an object recognition section 34 which detects the target Ob included in the captured image and a position information calculation section 35 which calculates position information indicating a position of the detected target Ob relative to the own vehicle CS.

The object recognition section 34 calculates a motion vector of each pixel in the captured image. The motion vector is a vector indicating a direction and magnitude of time-series change in each pixel constituting the target Ob. A value of the motion vector is calculated on the basis of a frame image at each time point which constitutes the captured image. Subsequently, the object recognition section 34 labels pixels whose motion vectors have the same direction and magnitude, and extracts, as the target Ob in the captured image, the smallest rectangular region R which surrounds the labeled pixels. Then, the object recognition section 34 recognizes the type of the target Ob by performing well-known template matching with respect to the extracted rectangular region R.

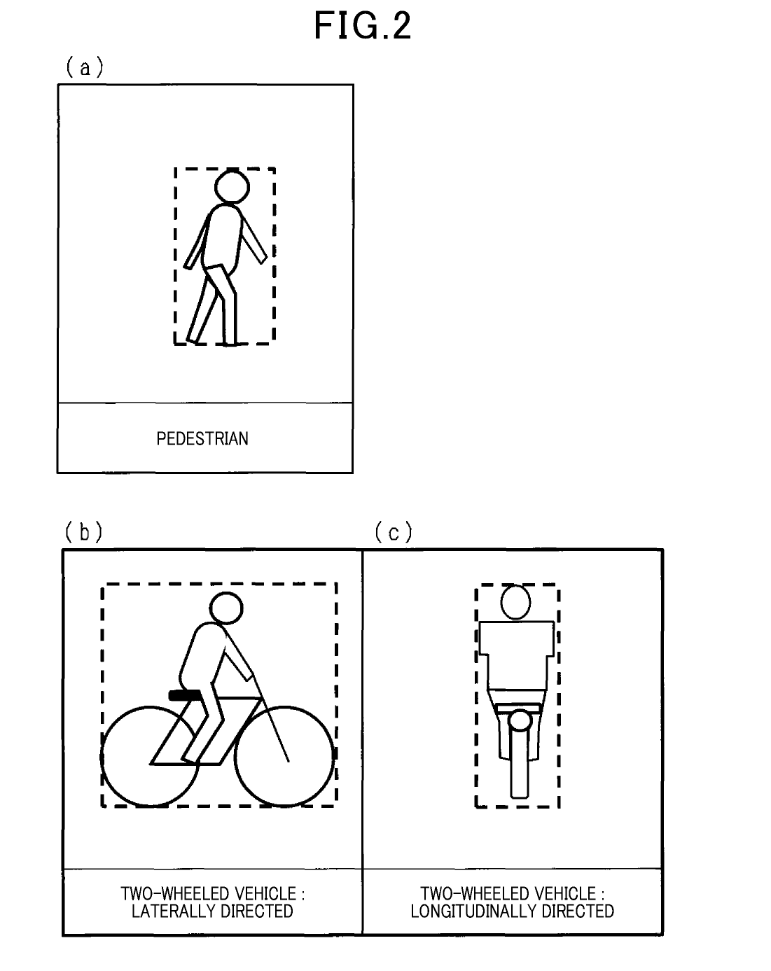

FIG. 2 is a view illustrating types of the target Ob recognized by the object recognition section 34. As the type of the target Ob, the object recognition section 34 recognizes a pedestrian, a laterally directed two-wheeled vehicle, and a longitudinally directed two-wheeled vehicle. FIG. 2 (a) indicates the pedestrian, FIG. 2 (b) indicates the laterally directed two-wheeled vehicle, and FIG. 2 (c) indicates the longitudinally directed two-wheeled vehicle. For example, the object recognition section 34 determines the direction of the two-wheeled vehicle on the basis of the motion vector described above. When the direction of the motion vector changes to a direction of the imaging axis of the camera sensor 31, the object recognition section 34 determines that the two-wheeled vehicle is directed longitudinally relative to the own vehicle CS. When the direction of the motion vector changes to a direction orthogonal to the imaging axis of the camera sensor 31, the object recognition section 34 determines that the two-wheeled vehicle is directed laterally relative to the own vehicle CS.

Instead of the motion vector, the object recognition section 34 may use a Histogram of Oriented Gradient (HOG) to recognize the target Ob and determine the direction of the target Ob.

The position information calculation section 35 calculates lateral position information on the target Ob on the basis of the recognized target Ob. The lateral position information includes the position of the center of the target Ob and positions of both ends of the target Ob in the captured image. For example, the positions of both ends indicate coordinates at both ends of the rectangular region R indicating a region of the target Ob recognized in the captured image.

The radar sensor 40 is provided on the front side of the own vehicle CS, recognizes the target Ob which is located ahead of the own vehicle, and calculates a distance between the own vehicle and the target Ob, a relative speed between the own vehicle and the target Ob, and the like. The radar sensor 40 includes a light emitting section which emits laser light toward a predetermined region ahead of the own vehicle and a light receiving section which receives reflected waves of the laser light emitted toward the region ahead of the own vehicle. The radar sensor 40 is configured such that the light receiving section scans the predetermined region ahead of the own vehicle in a predetermined cycle. The radar sensor 40 detects a distance to the target Ob which is present ahead of the own vehicle CS, on the basis of a signal corresponding to the time required until reflected waves of laser light is received by the light receiving section after the laser light is emitted from the light emitting section and a signal corresponding to an incident angle of the reflected waves.

The ECU 20 is constituted as a well-known computer which includes a CPU, a ROM, a RAM, and the like. The ECU 20 performs control regarding the PCS for the own vehicle CS by executing a program stored in the ROM. In the PCS, the ECU 20 calculates TTC which is the estimated time until the own vehicle CS and the target Ob collide with each other. The ECU 20 controls operation of the brake unit 25 on the basis of the calculated TTC. A unit controlled by the PCS is not limited to the brake unit 25 and may be a seat belt unit, an alarm unit, or the like.

When the ECU 20 has recognized the target Ob as a two-wheeled vehicle by an object detection process described later, the ECU 20 causes the PCS to be less likely to be activated as compared with when the ECU 20 has recognized the target Ob as a pedestrian. Even when a two-wheeled vehicle is traveling in the same direction as the own vehicle CS, for a two-wheeled vehicle, wobbling in a lateral direction (change in the lateral direction in movement) is more likely to occur than for a pedestrian. Accordingly, by causing the PCS to be less likely to be activated when the target Ob has been recognized as a two-wheeled vehicle, the ECU 20 prevents erroneous activation of the PCS caused by wobbling. For example, when the target Ob has been recognized as a two-wheeled vehicle, the ECU 20 sets a collision determination region used for determining a collision position to be smaller as compared with when the target Ob has been recognized as a pedestrian. In the present embodiment, the ECU 20 functions as a collision avoidance control section.

The brake unit 25 functions as a brake apparatus which reduces a vehicle speed V of the own vehicle CS. Furthermore, the brake unit 25 provides automatic braking for the own vehicle CS on the basis of control by the ECU 20. The brake unit 25 includes, for example, a master cylinder, a wheel cylinder which applied braking force to a wheel, and an ABS actuator which adjusts distribution of pressure (hydraulic pressure) from the master cylinder to the wheel cylinder. The ABS actuator is connected to the ECU 20 and adjusts an amount of braking to the wheel by adjusting the hydraulic pressure from the master cylinder to the wheel cylinder by being controlled by the ECU 20.

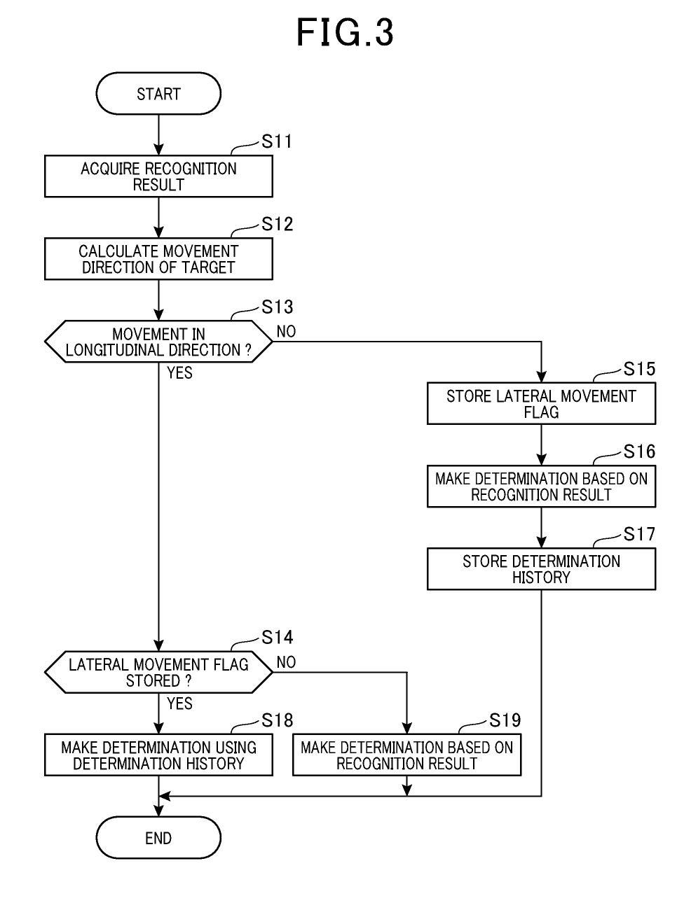

The following will describe, with reference to FIG. 3, the object detection process for detecting the target Ob on the basis of a recognition result acquired from the camera sensor 31. The object detection process shown in FIG. 3 is performed by the ECU 20 in a predetermined cycle. When the process in FIG. 3 is performed, the type of the target Ob in the captured image has been recognized by the camera sensor 31.

In step S11, a recognition result is acquired from the camera sensor 31. In the present embodiment, as the recognition result, the type of the target Ob and lateral position information on the target Ob are acquired from the camera sensor 31.

In step S12, a movement direction of the target Ob is calculated. The movement direction of the target Ob is calculated on the basis of time-series change in the lateral position information acquired from the camera sensor 31. For example, the time-series change in the position of the center in the lateral position information is used when the movement direction of the target Ob is calculated.

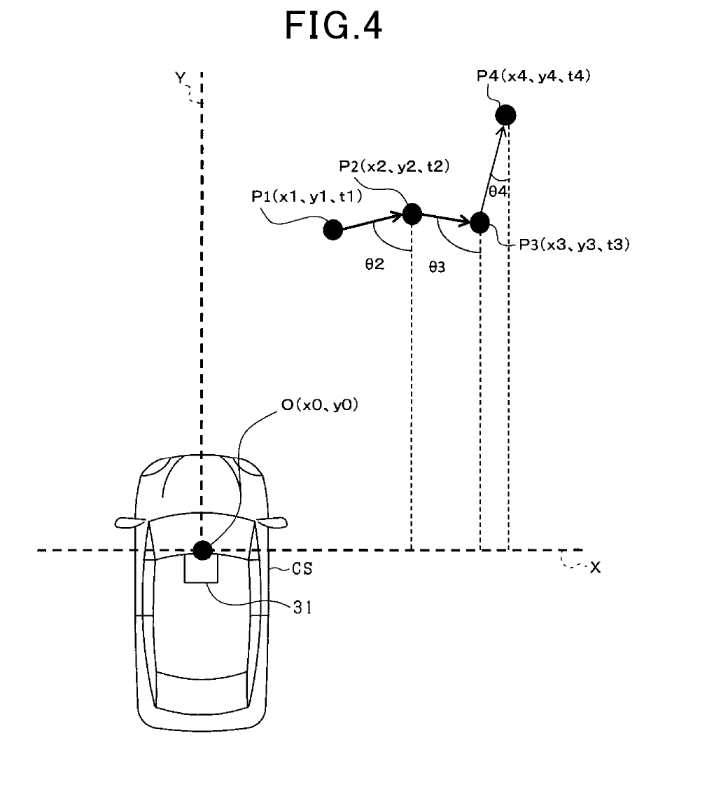

FIG. 4 is a view illustrating calculation of the movement direction of the target Ob in step S12. FIG. 4 illustrates relative coordinates in which a position O (x0, y0) of the camera sensor 31 is a reference point, an imaging axis Y of the camera sensor 31 from the position O (x0, y0) is a longitudinal axis, and a line orthogonal to the imaging axis Y is a lateral axis. FIG. 4 illustrates a function in which P (x, y, t) is a position of the target Ob at each time point. Note that x indicates a coordinate on the imaging axis Y in the relative coordinates in FIG. 4, and y indicates a coordinate on a lateral axis X intersecting the imaging axis Y in the relative coordinates in FIG. 4. Furthermore, t indicates a time at which the target Ob is located at the point P.

As illustrated in FIG. 4, the movement direction of the target Ob at a given time t can be calculated by an angle θ which is formed by a vector indicating an amount of change in position of the target Ob over a predetermined time period and the imaging axis Y. For example, when the position of the target Ob has changed from a position P1 to a position P2, the vector and the imaging axis Y form an angle θ2. When the target Ob moves from the position P1 to a position P3, a large amount of change occurs in a component x along the lateral axis X, and a value of the angle θ is within a predetermined value range. On the other hand, when the target Ob moves from the position P3 to a position P4, a large amount of change occurs in a component y along the imaging axis Y, and a value of the angle θ is less than a predetermined value or a predetermined value or more. Accordingly, the movement direction of the target Ob at the given time t can be calculated by using the angle θ relative to the imaging axis Y.

Again, in FIG. 3, in step S13, it is determined whether the movement of the target Ob is movement in a longitudinal direction (second direction) in which recognition accuracy of the camera sensor 31 is low or movement in a lateral direction (first direction) in which the recognition accuracy is high. In this embodiment, the lateral direction is a direction along the lateral axis X in FIG. 4, and the longitudinal direction is a direction along the imaging axis Y. Step S13 functions as a movement determination section and a movement determination step.

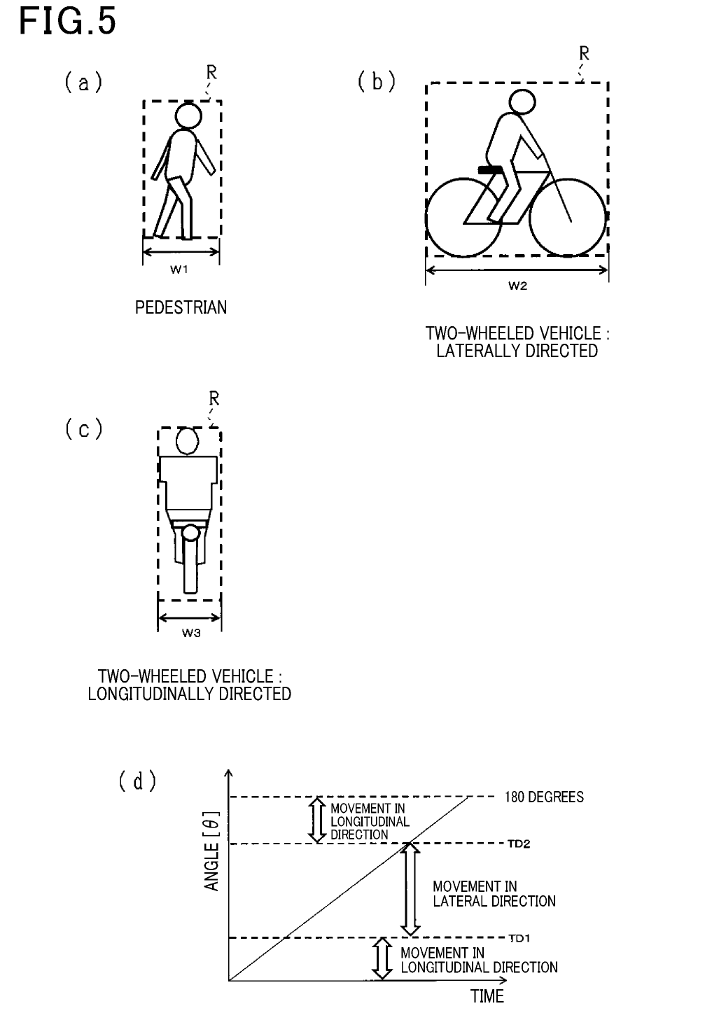

A relationship between the recognition accuracy of the camera sensor 31 and the movement direction of the target Ob will be described with reference to FIG. 5. When a two-wheeled vehicle moves in a direction of the lateral axis X (FIG. 5 (b)), a width W2 of a rectangular region R surrounding the two-wheeled vehicle is greater than a width W1 of a rectangular region R surrounding a pedestrian (FIG. 5 (a)). Accordingly, the pedestrian and the two-wheeled vehicle greatly differ from each other in characteristics, and this allows the camera sensor 31 to recognize the pedestrian and the two-wheeled vehicle as different targets Ob. That is, when the movement of the target Ob is the movement in the lateral direction, the recognition accuracy of the camera sensor 31 is high.

When the two-wheeled vehicle moves in a direction of the imaging axis Y of the camera sensor 31 (FIG. 5 (c)), the width W1 of the rectangular region R surrounding the pedestrian (FIG. 5 (a)) and a width W3 of a rectangular region R surrounding the two-wheeled vehicle have similar values. Since the pedestrian and the rider of the two-wheeled vehicle are both humans, the pedestrian and the rider of the two-wheeled vehicle have a common characteristic amount.

Accordingly, the camera sensor 31 may erroneously recognize the pedestrian and the two-wheeled vehicle as the same target Ob. That is, when the movement of the target Ob is the movement in the longitudinal direction, the recognition accuracy of the camera sensor 31 is low.

The ECU 20 makes the determination in step S13 by determining, using a threshold TD, the angle θ calculated as the movement direction of the target Ob in step S12. In the present embodiment, as shown in FIG. 5 (d), if a value of the angle θ is a threshold TD1 or more and less than a threshold TD2, the movement direction has a large number of components of the lateral axis X in the relative coordinates, and the ECU 20 determines that the movement of the target Ob is the movement in the lateral direction. On the other hand, if a value of the angle θ is less than the threshold TD1 or the threshold TD2 or more, the movement direction has a large number of components of the imaging axis Y in the relative coordinates, and the ECU 20 determines that the movement of the target Ob is the movement in the lateral direction. For example, the threshold TD1 and the threshold TD2 are set such that the relationship TD1<TD2 is established and the threshold TD1 and the threshold TD2 each have a value of 180 degrees or less.

Again, in FIG. 3, when the movement of the target Ob is the movement in the lateral direction (NO in step S13), in step S15, a lateral movement flag is stored. The lateral movement flag is a flag indicating that the target Ob has undergone the movement in the lateral direction.

In step S16, the type of the target Ob is determined on the basis of the recognition result related to the target Ob obtained by the camera sensor 31. In this case, the recognition accuracy of the camera sensor 31 is determined to be high, and the type of the target Ob is determined on the basis of the type of the target Ob acquired from the camera sensor 31 in step S11. Step S16 functions as a first type determination section and a first type determination step.

In step S17, the current recognition result related to the target Ob is stored in a determination history. That is, the determination result related to the target Ob in step S16 when the recognition accuracy is high is stored in the determination history.

On the other hand, if, in step S13, the movement of the target Ob has been determined to be movement in the longitudinal direction (YES in step S13), in step S14, it is determined whether the lateral movement flag is stored. If the lateral movement flag is not stored (NO in step S14), the type of the target Ob has not been stored in the determination history, and thus in step S19, the type of the target Ob is determined on the basis of the recognition result related to the target Ob obtained by the camera sensor 31. Step S19 functions as a third type determination section and a third type determination step.

On the other hand, if the lateral movement flag has been stored (YES in step S14), in step S18, the type of the target Ob is determined on the basis of the determination history. Even when the movement of the target Ob is the movement in the longitudinal direction in which the recognition accuracy of the camera sensor 31 is low, the type of the target Ob is determined by using the determination history stored when the recognition accuracy is high. Thus, when the recognition result (type) acquired in step S11 differs from the type stored in the determination history, the type of the target Ob determined by the ECU 20 differs from the recognition result obtained by the camera sensor 31. Step S18 functions as a second type determination section and a second type determination step.

When step S18 or step S19 has been performed, the type recognition process shown in FIG. 3 halts.

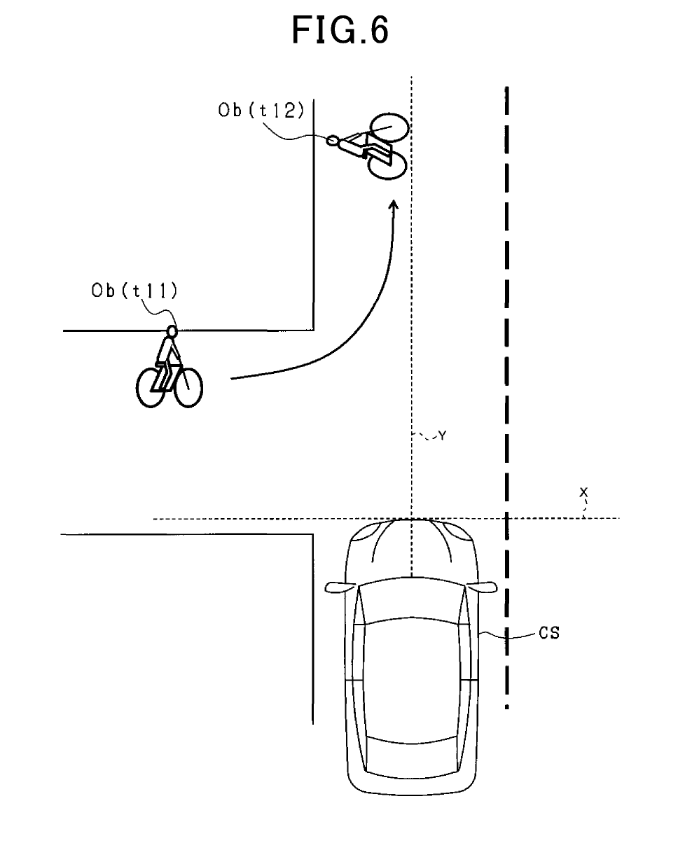

The following will describe, with reference to FIG. 6, the determination of the type of the target Ob by the object detection process shown in FIG. 3. FIG. 6 illustrates an example in which the type of the target Ob is a two-wheeled vehicle and movement of the target Ob changes from the movement in the lateral direction to movement in the longitudinal direction.

At time t11, the target Ob is moving in a direction intersecting the imaging axis Y of the camera sensor 31, and the movement of the target Ob is determined to be movement in the lateral direction. Accordingly, the type of the target Ob at time t11 is determined on the basis of the recognition result acquired from the camera sensor 31. Since the movement of the target Ob has been determined to be movement in the lateral direction, the type of the target Ob at time t11 is stored in the determination history.

Assume that the target Ob has turned left at an intersection so that the movement of the target Ob has changed to movement in the direction of the imaging axis Y. The movement of the target Ob at time t12 is determined to be movement in the longitudinal direction in which the recognition accuracy of the camera sensor 31 decreases. Accordingly, the determination history stored at time t11 is used to determine the type of the target Ob acquired from the camera sensor 31. For example, even when the recognition result obtained by the camera sensor 31 at time t12 indicates that the type of the target Ob is a pedestrian, the ECU 20 determines that the type of the target Ob is a two-wheeled vehicle.

Then, when the movement of the target Ob is continuously determined to be movement in the longitudinal direction, the type of the target Ob is determined by using the determination history stored at time t11 (in this case, two-wheeled vehicle).

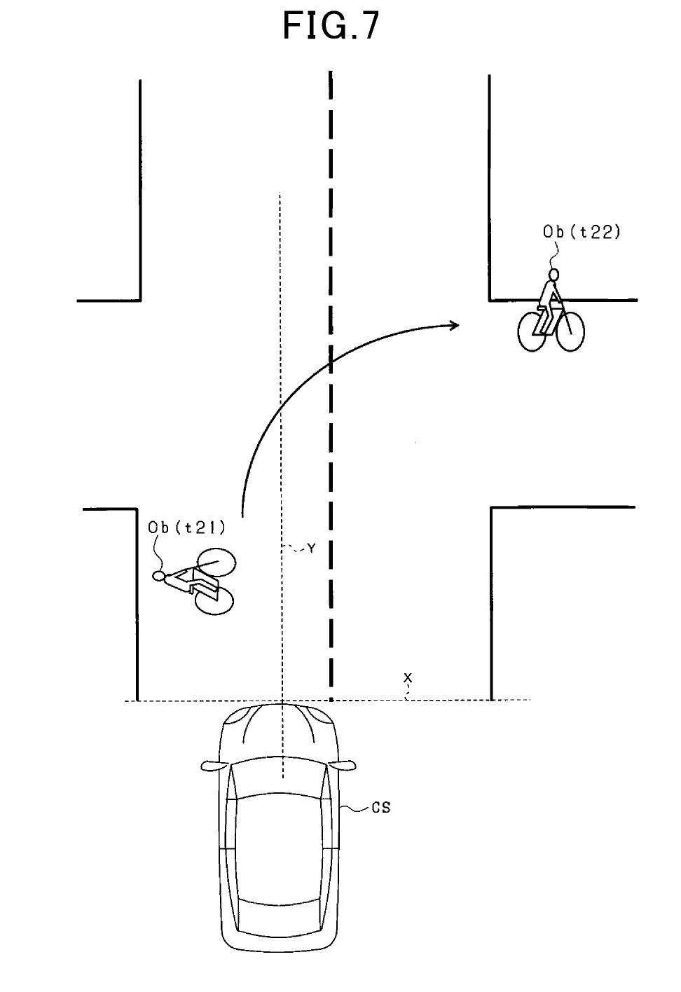

FIG. 7 illustrates an example in which the type of the target Ob is a two-wheeled vehicle and movement of the target Ob changes from the movement in the longitudinal direction to the movement in the lateral direction.

At time t21, the target Ob moves in the direction of the imaging axis Y, and thus the movement of the target Ob is determined to be movement in the longitudinal direction. In this example, the target Ob has not previously undergone the movement in the lateral direction, and thus the type of the target Ob at time t21 is determined on the basis of the recognition result acquired from the camera sensor 31.

Assume that the target Ob has turned right at an intersection so that the movement direction of the target Ob has changed. At time t22, the movement of the target Ob is determined to be movement in the lateral direction, and thus the type of the target Ob is determined on the basis of an output from the camera sensor 31. Then, when the movement of the target Ob is the movement in the lateral direction, the type of the target Ob is determined on the basis of the recognition result acquired from the camera sensor 31.

As has been described, when the ECU 20 has determined that the movement of the target Ob is movement in the lateral direction in which the recognition accuracy of the camera sensor 31 is high, the ECU 20 determines the type of the object on the basis of the recognition result acquired during the movement in the lateral direction. Furthermore, when the ECU 20 has determined that the movement of the target Ob has changed from movement in the lateral direction to movement in the longitudinal direction, the ECU 20 determines the type of the target Ob by using the determination history stored during the movement in the lateral direction which has already been determined. Accordingly, even when the movement of the target Ob is movement in the longitudinal direction, the type of the target Ob can be determined on the basis of the type of the target Ob acquired during movement in the lateral direction in which the recognition accuracy is high, and this makes it possible to prevent erroneous determination.

The type of the target Ob includes a pedestrian and a two-wheeled vehicle, and the ECU 20 sets the lateral direction to be a direction orthogonal to the imaging axis Y of the camera sensor 31 and the longitudinal direction to be the same direction as the imaging axis Y. The pedestrian and the two-wheeled vehicle are similar in width when viewed from the front and have the same characteristics because a rider of the two-wheeled vehicle and the pedestrian are both humans. When a movement direction of the two-wheeled vehicle is a direction intersecting the direction of the imaging axis, the width of the two-wheeled vehicle detected by the camera sensor 31 greatly differs from the width of the pedestrian detected by the camera sensor 31, and this allows the camera sensor 31 to recognize the two-wheeled vehicle and the pedestrian as different types. On the other hand, when the movement direction of the two-wheeled vehicle is the direction of the imaging axis, the camera sensor 31 may erroneously recognize the two-wheeled vehicle and the pedestrian as the same type. Thus, even in the detection of the pedestrian and the two-wheeled vehicle in which erroneous recognition is more likely to occur, the ECU 20 can prevent erroneous determination of the type of the target Ob.

The ECU 20 performs, with respect to the own vehicle CS, collision avoidance control for avoiding a collision between the target Ob and the own vehicle CS. Under the collision avoidance control, when the target Ob has been recognized as a two-wheeled vehicle, the ECU 20 causes the collision avoidance control to be less likely to be activated as compared with when the target Ob has been recognized as a pedestrian. In a case of a two-wheeled vehicle, wobbling which is change in the lateral direction in movement is more likely to occur, and this may cause erroneous activation of the PCS. Thus, the above configuration makes it possible to prevent erroneous activation of the PCS.

When the movement of the target Ob is the movement in the longitudinal direction and there is no history of the movement in the lateral direction, the ECU 20 determines the type of the target Ob on the basis of the recognition result acquired during the movement in the longitudinal direction. When the target Ob has not undergone movement in the lateral direction, the correct type of the target Ob cannot be determined. In such a case, therefore, the ECU 20 determines the type of the target Ob on the basis of the detection result obtained by the camera sensor 31.

### Second Embodiment

In a case where the ECU 20 acquires the type of the target Ob and the direction of the target Ob as a recognition result obtained by the camera sensor 31, when, although the ECU 20 has determined that movement of the target Ob is the movement in the lateral direction, the camera sensor 31 has recognized the target Ob as a longitudinally directed two-wheeled vehicle, the ECU 20 may reject the recognition result acquired from the camera sensor 31.

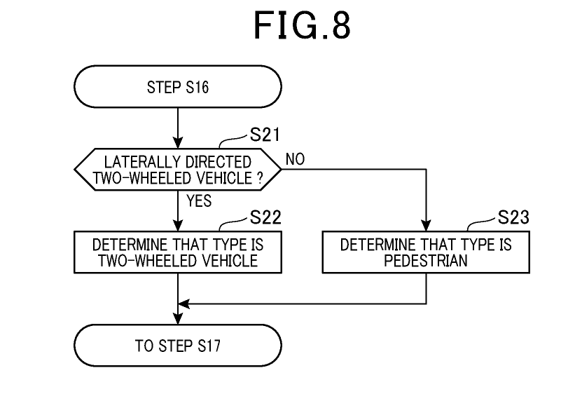

FIG. 8 is a flow chart showing a process performed by the ECU 20 in the second embodiment. The process shown in FIG. 8 is the process performed in step S16 in FIG. 3 and the process which is performed after, in step S13, the movement of the target Ob is determined to be movement in the lateral direction in which the recognition accuracy of the camera sensor 31 is high.

In step S21, it is determined whether the type of the target Ob is a laterally directed two-wheeled vehicle or not, on the basis of the recognition result acquired from the camera sensor 31.

If the type of the target Ob is a laterally directed two-wheeled vehicle (YES in step S21), in step S22, the type of the target Ob is determined to be a two-wheeled vehicle. The laterally directed two-wheeled vehicle travels in the direction orthogonal to the imaging axis Y of the camera sensor 31 relative to the own vehicle CS, and thus the movement of the laterally directed two-wheeled vehicle is movement in the lateral direction. Accordingly, the recognition result obtained by the camera sensor 31 agrees with the movement direction of the target Ob determined by the ECU 20, and thus the ECU 20 has determined that the recognition made by the camera sensor 31 is correct.

On the other hand, if the type of the target Ob is not a laterally directed two-wheeled vehicle (NO in step S21), in step S23, the type of the target Ob is determined to be a pedestrian. In this case, a pedestrian may have been erroneously recognized as a two-wheeled vehicle, and thus the type of the target Ob is determined to be a pedestrian.

As has been described, in the second embodiment, the recognition result acquired from the camera sensor 31 includes, as the type of the target Ob, a pedestrian, a laterally directed two-wheeled vehicle which is moving in the lateral direction, and a longitudinally directed two-wheeled vehicle which is moving in the longitudinal direction. In a case where the ECU 20 has determined that the movement of the target Ob is movement in the lateral direction, if the recognition result indicates that the type of the target Ob is a laterally directed two-wheeled vehicle, the ECU 20 determines that the type of the target Ob is a two-wheeled vehicle. In a case where the ECU 20 has determined that the movement of the target Ob is movement in the longitudinal direction, if the recognition result indicates that the type of the target Ob is a pedestrian or a longitudinally directed two-wheeled vehicle, the ECU 20 determines that the type of the target Ob is a pedestrian.

Even when the movement direction of the target Ob is the lateral direction in which the recognition accuracy is high, the target Ob may have been erroneously recognized. The direction of a two-wheeled vehicle agrees with the movement direction of the two-wheeled vehicle, and thus when the target Ob has been recognized as a laterally directed two-wheeled vehicle, the movement of the laterally directed two-wheeled vehicle can be determined to be movement in the lateral direction, and when the target Ob has been recognized as a longitudinally directed two-wheeled vehicle, the movement of the longitudinally directed two-wheeled vehicle can be determined to be movement in the longitudinal direction. Thus, if the recognition result obtained by the camera sensor 31 agrees with the determination result obtained by the ECU 20, the type of the target Ob is determined to be a two-wheeled vehicle. However, if the ECU 20 has determined that the movement of the target Ob is movement in the lateral direction but the recognition result obtained by the camera sensor 31 indicates that the type of the target Ob is a longitudinally directed two-wheeled to vehicle, the movement direction of the target Ob determined by the ECU 20 does not agree with the recognition result obtained by the camera sensor 31, and thus a pedestrian may have been erroneously recognized as a two-wheeled vehicle. In such a case, therefore, by determining that the target Ob is a pedestrian, it is possible to correct erroneous recognition made when the recognition accuracy of the camera sensor 31 is high.

### Third Embodiment

When movement of the target Ob which has been moving toward the own vehicle CS has changed from movement in the lateral direction to movement in the longitudinal direction, the ECU 20 may determine the type of the target Ob by using the determination history which has already been stored.

For example, in step S13 in FIG. 3, the ECU 20 determines whether the movement direction of the target Ob is the lateral direction in which the recognition accuracy of the camera sensor 31 is high and the target Ob is moving toward the own vehicle CS. If an affirmative determination is made in step S13 (YES in step S13), in step S15, the ECU 20 stores a lateral movement flag. Then, the ECU 20 performs determination of the type of the target Ob in step S16 and storing of the determination history in step S17.

It is preferable to limitedly perform the determination for the target Ob by the ECU 20 using the determination history because the type of the target Ob is determined on the basis of the previous determination history. Accordingly, the ECU 20 determines the type of the target Ob by using the determination history only when the target Ob has moved toward the own vehicle CS. This makes it possible to limitedly perform the process by the ECU 20 only when necessary.

### OTHER EMBODIMENTS

The calculation in step S12 in FIG. 3 of the angle θ relative to the imaging axis Y of the camera sensor 31 as the movement direction of the target Ob is merely an example. Alternatively, the angle θ may be calculated relative to the lateral axis X orthogonal to the imaging axis Y of the camera sensor 31. In such a case, in step S13, if a value of the angle θ is less than the threshold TD1 or the threshold TD2 or more, the ECU 20 determines that the movement of the target Ob is movement in the lateral direction. On the other hand, if a value of the angle θ is the threshold TD1 or more and less than the threshold TD2, the ECU 20 determines that the movement of the target Ob is movement in the longitudinal direction.

The recognition of the type of the target Ob made by the camera sensor 31 is merely an example. Alternatively, the recognition of the type of the target Ob may be made by the ECU 20. In such a case, the ECU 20 functionally includes the object recognition section 34 and the position information calculation section 35 illustrated in FIG. 1.

The above description using a pedestrian and a two-wheeled vehicle as the target Ob recognized by the camera sensor 31 is merely an example. Alternatively, a four-wheel automobile, a sign, an animal, and the like may be determined as the type of the target Ob. Furthermore, when the relationship between the movement direction of the target Ob and the recognition accuracy of the camera sensor 31 varies depending on the type of the target Ob, the threshold TD (shown in FIG. 5 (d)) separating the movement in the lateral direction and the movement in the longitudinal direction may vary for each type of the target Ob.

The driving assistance apparatus 10 may be configured such that the target Ob is recognized on the basis of a recognition result related to the target Ob obtained by the camera sensor 31 and a detection result related to the target Ob obtained by the radar sensor 40.

The calculation of the movement direction of the target Ob in step S12 in FIG. 3 may be performed by using an absolute speed of the target Ob. In such a case, in step S12, the ECU 20 calculates the movement direction of the target Ob by calculating the movement direction using the absolute speed of the target Ob and then calculating deviation in the movement direction relative to the direction of travel of the own vehicle CS.

The present disclosure is described based the embodiments, but the present disclosure is considered not to be limited to the embodiments or the configurations. The present disclosure encompasses various modified examples and variations in an equivalent range. In addition, the scope and the spirit of the present disclosure encompasses various combinations and forms and other combinations and forms including only one element, one or more elements, or one or less elements of those.

1. A vehicle control apparatus which acquires a recognition result related to an object based on an image captured by an imaging means controls a vehicle based on the recognition result, the vehicle control apparatus comprising:
a movement determination section which determines whether the object is moving in a first direction in which recognition accuracy for the object is high or the object is moving in a second direction in which the recognition accuracy is lower than that in the first direction;
a first type determination section which determines a type of the object based on the recognition result at present time, when movement of the object is determined to be movement in the first direction by the movement determination section; and
a second type determination section which determines the type of the object by using a determination history related to the type of the object determined by the first type determination section, when a determination result related to the movement of the object by the movement determination section has changed from the movement in the first direction to movement in the second direction.

2. The vehicle control apparatus according to claim 1, wherein
the type of the object includes a pedestrian and a two-wheeled vehicle; and
for determination of the type of the object, the movement determination section sets the first direction to be a direction orthogonal to a direction of an imaging axis of the imaging means and the second direction to be the same direction as the direction of the imaging axis.

3. The vehicle control apparatus according to claim 2, further comprising a collision avoidance control section which performs, with respect to the vehicle, collision avoidance control for avoiding a collision between the object and the vehicle, wherein:
when the object has been determined to be the two-wheeled vehicle, the collision avoidance control section causes the collision avoidance control to be less likely to be activated as compared with when the object has been determined to be the pedestrian.

4. The vehicle control apparatus according to claim 1, further comprising a third type determination section which determines the type of the object based on the recognition result acquired during the movement in the second direction, when the movement of the object is the movement in the second direction and the determination history includes no history of the movement in the first direction.

5. The vehicle control apparatus according to claim 1, wherein:
the recognition result includes, as the type of the object, a pedestrian, a laterally directed two-wheeled vehicle which is moving in the first direction, and a longitudinally directed two-wheeled vehicle which is moving in the second direction; and
in a case where the movement of the object has been determined to be movement in the first direction, when the recognition result indicates that the type of the object is the laterally directed two-wheeled vehicle, the first type determination section determines that the type of the object is the two-wheeled vehicle, and when the recognition result indicates that the type of the object is the pedestrian or the longitudinally directed two-wheeled vehicle, the first type determination section determines that the type of the object is the pedestrian.

6. The vehicle control apparatus according to claim 1, wherein when movement of the object which has been laterally moving toward an own vehicle has changed from the movement in the first direction to the movement in the second direction, the second type determination section determines the type of the object by using the determination history stored by the first type determination section.

7. A vehicle control method of acquiring a recognition result related to an object based on an image captured by an imaging means and controlling a vehicle based on the recognition result, the vehicle control method comprising:
a movement determination step in which it is determined whether movement of the object relative to an own vehicle is movement in a first direction in which recognition accuracy for the object is high or movement in a second direction in which the recognition accuracy is lower than that in the first direction;
a first type determination step in which a type of the object is determined based on the recognition result at present time, when the movement of the object is determined to be the movement in the first direction in the movement determination step; and
a second type determination step in which the type of the object is determined by using a determination history related to the type of the object determined in the first type determination step, when a determination result related to the movement of the object in the movement determination step has changed from the movement in the first direction to the movement in the second direction.
